(19) United States
(12) Patent Application Publication
(10) Pub. No.: US 2025/0284313 A1
(43) Pub. Date: Sep. 11, 2025

(54) NOTEBOOK COMPUTER CAPABLE OF CONVENIENTLY ADJUSTING ANGLE OF UPPER COVER THEREOF, AND METHOD FOR ADJUSTING ANGLE OF UPPER COVER

(71) Applicant: SHANGHAI FSMY TECHNOLOGIES CO., LTD, Shanghai (CN)

(72) Inventor: Wenjie ZHU, Shanghai (CN)

(21) Appl. No.: 18/853,120

(22) PCT Filed: Mar. 30, 2023
(86) PCT No.: PCT/CN2023/084981

§ 371 Date: May 27, 2025

(30) Foreign Application Priority Data
Apr. 22, 2022 (CN) 202210429491.6

(51) Int. Cl. G06F 1/16

(52) U.S. Cl. CPC G06F 1/162; G06F 1/1637

(57) ABSTRACT

The invention provides a notebook computer capable of conveniently adjusting an angle of an upper cover thereof, and a method for adjusting the angle of the upper cover. The notebook computer is equipped with a plurality of shortcut keys and an angle sensor. A user may bind different shortcut keys to different angles through a first operation, with the angles detected by the angle sensor. When the user performs a second operation on a specific shortcut key, the upper cover can be rotated to a position corresponding to a specific angle, enabling quick and convenient adjustment of the angle of the upper cover for different usage scenarios, while also preventing potential damage to the notebook computer.

### FIELD OF TECHNOLOGY

The invention belongs to the technical field of notebook computers, and particularly relates to a notebook computer capable of conveniently adjusting an angle of an upper cover thereof, and a method for adjusting the angle of the upper cover.

### BACKGROUND TECHNOLOGY

Notebook computers are widely used due to their portability, providing a great user experience whether for business or home use, and the number of users is steadily increasing.

Inventors have been dedicated to researching a new type of notebook computer that significantly differs from the computers currently available on the market, aiming for a more practical design that addresses the pain points of existing products.

Through careful observation and rigorous analysis, developers have discovered that users have varying angle preferences for the upper cover of the notebook computer in different scenarios. Manually adjusting the angle may lead to uneven pressure on the screen, risking damage (such as to the hinges or display). Users must adjust the angle multiple times to find the right position, and every time their usage scenario changes, readjustment is required, which is inconvenient. Additionally, the power button can only be activated after the upper cover is opened, and the same applies to starting software and shutting down the computer, which is quite time-consuming. Although current notebook computers can automatically open or close the upper cover, such as in the Chinese invention patent application CN101697089A, which describes a notebook computer that automatically opens and closes the cover when powered on and off, their designs still lack the ability to quickly and conveniently adjust the angle of the upper cover for different usage scenarios. To bring this product to market, we face immense pressure and challenges: on one hand, we need to ensure the design is innovative and creative (with a certain level of complexity), while on the other, we must simplify the design (only cost-effective designs can be put into actual production) to ensure practicality.

### SUMMARY OF THE PRESENT INVENTION

### Technical Problems

Developers have discovered that users have varying angle preferences for the upper cover of the notebook computer in different scenarios. Manually adjusting the angle may lead to uneven pressure on the screen, risking damage (such as to the hinges or display). Typically, users must adjust the angle multiple times to find the right position, and every time their usage scenario changes, readjustment is required, which is quite inconvenient. Additionally, the power button can only be activated after the upper cover is opened, and the same applies to starting software and shutting down the computer, which is quite time-consuming.

### Technical Solutions

In view of the above technical problems, the inventors have made unremitting efforts to provide a notebook computer capable of conveniently adjusting an angle of an upper cover thereof, and a method for adjusting the angle of the upper cover.

In order to solve the above technical problems, the technical scheme adopted by the invention is as follows.

In one aspect, the invention provides a notebook computer capable of conveniently adjusting an angle of an upper cover thereof, comprising a shell, wherein the shell comprises an upper cover and a main housing which are rotatably coupled, and the upper cover rotates under the control of a controller to adjust the angle. The notebook computer further comprises a plurality of shortcut keys and an angle sensor for detecting the angle of the upper cover, the plurality of shortcut keys are arranged on the shell, and the shortcut keys and the angle sensor are all in signal connection with the controller. The controller is configured as follows:
in a powered-on state, upon receiving a first operation on the shortcut keys, the notebook computer obtains a current angle of the upper cover through the angle sensor, and records the one-to-one correspondence between the current shortcut key and the angle; and
in a powered-on state, upon receiving a first operation on the shortcut keys, the notebook computer obtains a current angle of the upper cover through the angle sensor, and records the one-to-one correspondence between the current shortcut key and the angle; and
in the powered-on state, upon receiving a second operation on the shortcut keys, the notebook computer identifies the angle corresponding to the current shortcut key according to the correspondence, and controls the upper cover to rotate to a position corresponding to the angle.

In another aspect, the invention also provides a method for adjusting the angle of the upper cover of the notebook computer, comprising the following steps:
in a powered-on state, performing a first operation on the shortcut keys, allowing the notebook computer to obtain a current angle of the upper cover through the angle sensor, and record the one-to-one correspondence between the current shortcut key and the angle; and
in the powered-on state, performing a second operation on the shortcut keys, allowing the notebook computer to identify the angle corresponding to the current shortcut key according to the correspondence, and control the upper cover to rotate to a position corresponding to the angle.

According to the invention, the notebook computer is equipped with the one or more shortcut keys and the angle sensor. The notebook computer allows different shortcut keys to be bound to different angles based on the received first operation, with the angles detected by the angle sensor. When the notebook computer receives the second operation on a specific shortcut key, the upper cover can be rotated to the position corresponding to a specific angle, enabling quick and convenient adjustment of the angle of the upper cover for different usage scenarios, while also preventing potential damage to the notebook computer.

### Beneficial Effects

Users have varying angle preferences for the upper cover of the notebook computer in different scenarios. Manually adjusting the angle may lead to uneven pressure on the screen, risking damage (such as to the hinges or display). Typically, users must adjust the angle multiple times to find the right position, and every time their usage scenario changes, readjustment is required, which is quite inconvenient. Additionally, the power button can only be activated after the upper cover is opened, and the same applies to starting software and shutting down the computer, which is quite time-consuming.

According to the invention, the notebook computer is equipped with the one or more shortcut keys and the angle sensor. The notebook computer allows different shortcut keys to be bound to different angles based on the received first operation, with the angles detected by the angle sensor. When the notebook computer receives the second operation on a specific shortcut key, the upper cover can be rotated to the position corresponding to a specific angle, enabling quick and convenient adjustment of the angle of the upper cover for different usage scenarios, while also preventing potential damage to the notebook computer.

### BRIEF DESCRIPTION OF THE DRAWINGS

The invention will be further explained with reference to the attached drawings and specific embodiments.

FIG. 1 is a perspective view of an embodiment of the invention;

FIG. 2 is a front view of FIG. 1;

FIG. 3 is a top view of FIG. 1;

FIG. 4 is a perspective view of another embodiment of the invention;

FIG. 5 is a front view of FIG. 4;

FIG. 6 is a top view of FIG. 4;

FIG. 7 is a control diagram of the invention; and

FIG. 8 is an example of the positions of a power key and a coupling member of the invention.

### PREFERRED EMBODIMENTS OF THE INVENTION

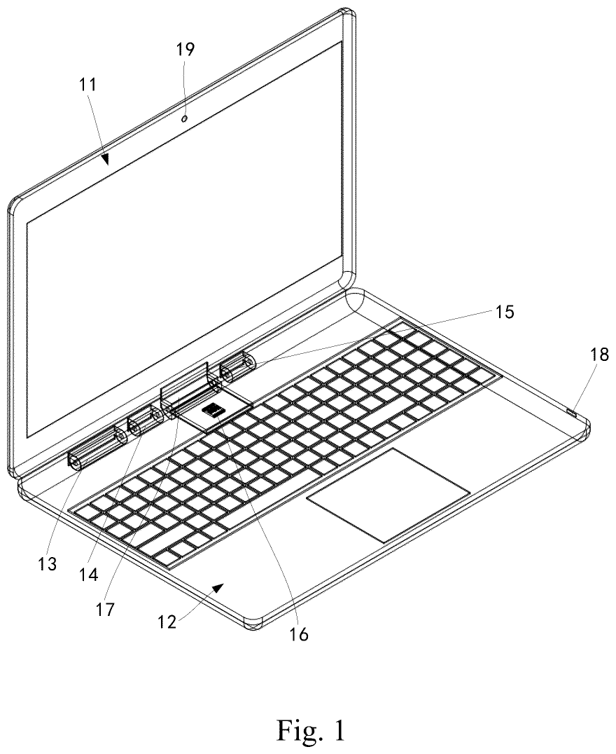

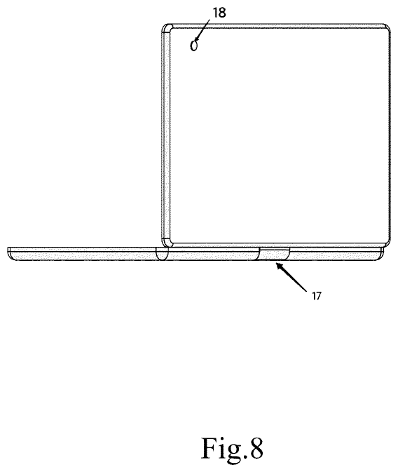

As shown in FIGS. 1 and 8, an embodiment of this specification provides a notebook computer capable of conveniently adjusting an angle of an upper cover thereof, comprising an upper cover 11, a main housing 12, a driving motor 13, one or more shortcut keys, an opening and closing key, an angle sensor 14 for detecting an angle of the upper cover 11, a pressure sensor 15 for detecting external pressure on the upper cover 11 and the main housing 12, and a controller 16.

A front side of the upper cover 11 is provided with a display screen and a camera 19, a main unit is arranged in the main housing 12, and an upper side of the main housing 12 is provided with a built-in keyboard and a built-in touchpad.

The upper cover 11 and the main housing 12 form a shell, and are rotatably coupled through a coupling member 17. The coupling member 17 is connected with the driving motor 13, and the driving motor 13 is controlled by the controller 16, so that the upper cover 11 can rotate under the control of the controller 16 to adjust the angle.

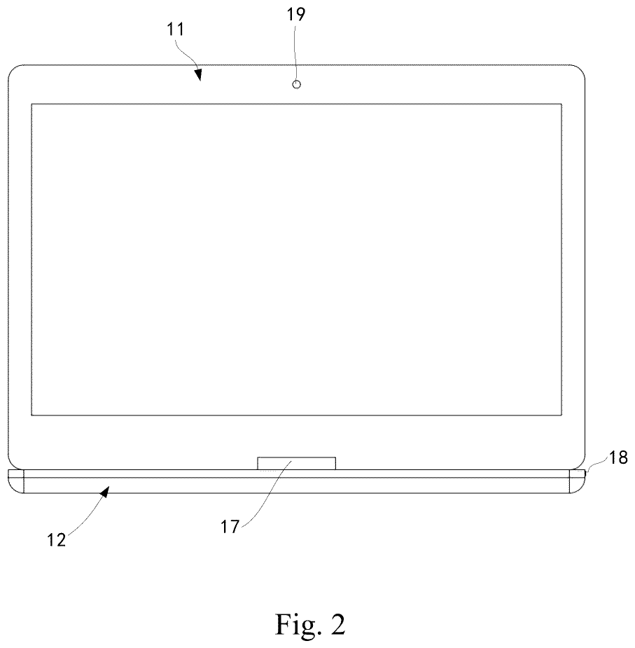

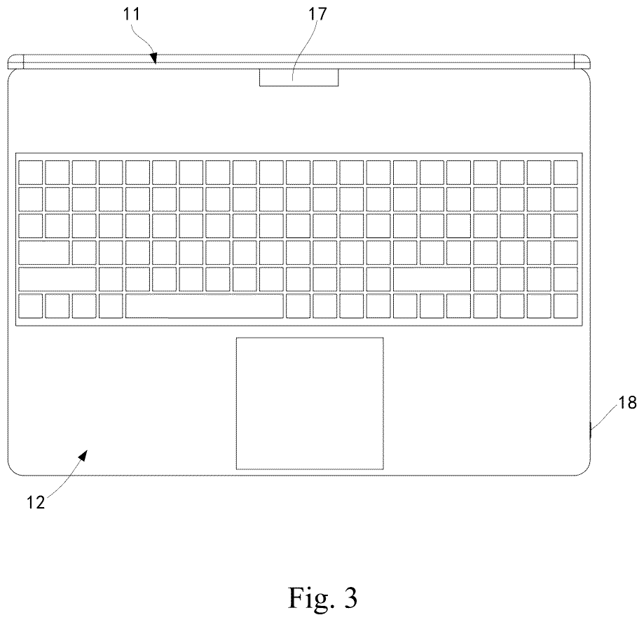

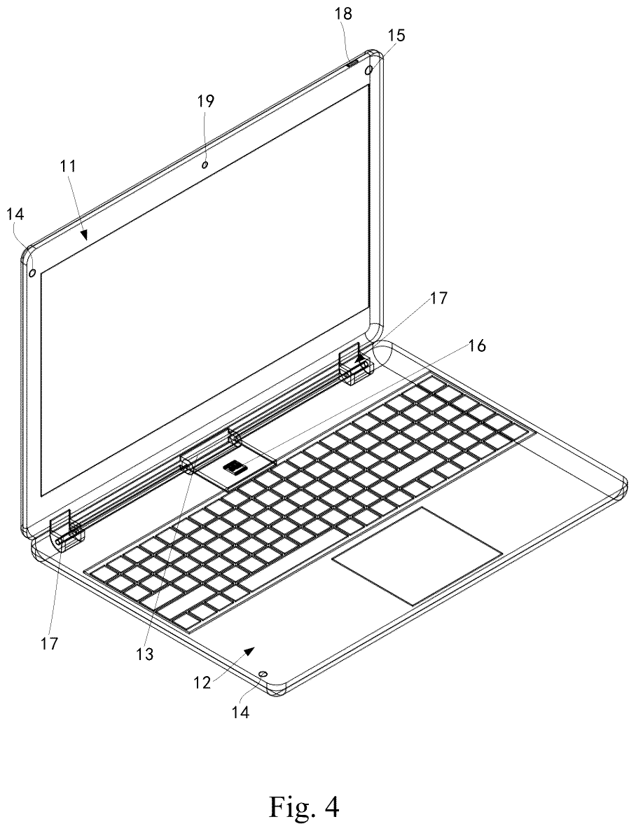

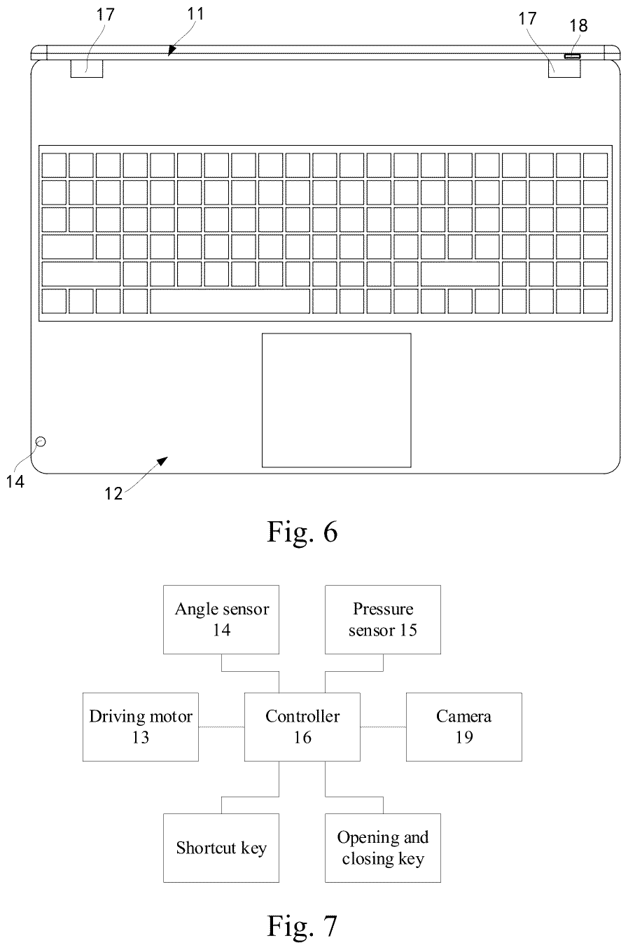

The upper cover 11 and the main housing 12 may be connected through a single coupling member 17, as shown in FIGS. 1-3. Alternatively, the upper cover 11 and the main housing 12 may be connected through two coupling members 17 positioned at a lateral distance from each other, as shown in FIGS. 4-6.

It should be pointed out that notebook computers on the market today require users to manually lift the upper cover. Since a single coupling member can be subject to uneven stress, and it can be challenging to open the upper cover with the hand placed on one side, users generally have to position their hand at the top center of the upper cover for easier opening. As a result, two coupling members are usually adopted. However, the upper cover 11 of the notebook computer in this invention opens automatically, thus avoiding issues of uneven force and difficulty in opening, which enables the use of a single coupling member and saves costs.

To make it easier to turn on the notebook computer, the power key 18 is positioned where it can be accessed while the upper cover is closed, such as on an outer side of a frame of the upper cover 11, as shown in FIGS. 4-6, so that the power key 18 can be operated without manually opening the upper cover 11. Of course, the power key 18 may also be arranged on an outer side of a frame of the main housing 12, as shown in FIGS. 1-3, or at any location on a surface of the main housing 12, as shown in FIG. 8.

The plurality of shortcut keys may be keys on the built-in keyboard, such as numeric keys, and of course, they may also be keys arranged on the shell and separate from the built-in keyboard.

The opening and closing key is arranged on the shell in a position that allows it to be operated even when the upper cover is closed. In this embodiment, the power key 18 may be used as the opening and closing key.

The angle sensor 14 may be arranged on and/or in the notebook computer. As shown in the figures, the angle sensor 14 may be arranged on the coupling member 17 or directly on a shaft of the driving motor 13, as shown in FIG. 1; of course, the angle sensor 14 may also be a photoelectric sensor, as shown in FIG. 4, the upper cover 11 and the main housing 12 are each provided with a photoelectric sensor, with the two photoelectric sensors working together: one emits a light signal while the other receives it, thus detecting the angle of the upper cover 11. This is merely an exemplary illustration of the angle sensor and is not intended to be the only option.

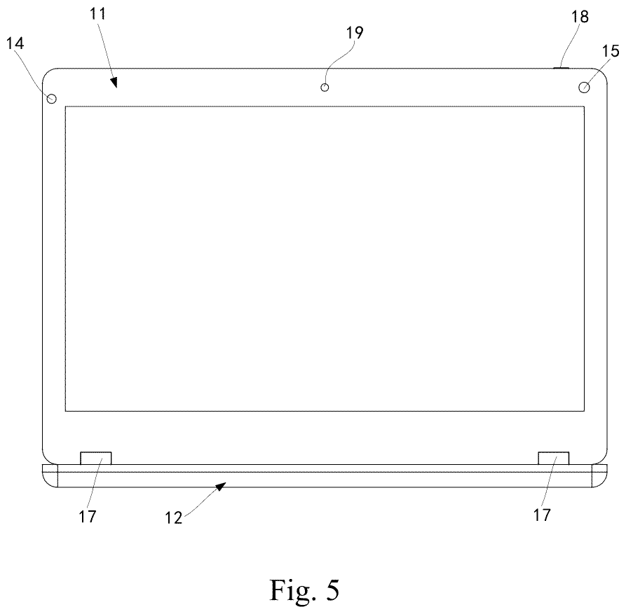

The pressure sensor 15 may be arranged in the notebook computer and/or on the shell. For example, the pressure sensor 15 is installed in the upper cover 11, as shown in FIGS. 4 and 5, or as shown in FIG. 1, the pressure sensor may also be installed in the main housing 12. Of course, the pressure sensors 15 may also be installed in both the upper cover 11 and the main housing 12. This is merely an exemplary illustration of the pressure sensor 15 and is not intended to be the only option.

As shown in FIG. 7, the plurality of shortcut keys, the opening and closing key, the angle sensor 14 and the pressure sensor 15 are all in signal connection with the controller 16.

In this embodiment, the controller 16 is a CPU of the notebook computer and/or an independent control chip. As shown in FIGS. 1 and 4, the controller 16 is an independent control chip, which can communicate with the CPU of the notebook computer when necessary.

It should be pointed out that the angle in the invention refers to an included angle between the upper cover 11 and the main housing 12.

In addition to the ability to manually open and close the upper cover, the notebook computer in this embodiment also has the following functions.

1. Automatically open the upper cover during startup (when the operating system is activated) and automatically close the upper cover during shutdown (when the operating system is turned off; after the upper cover is closed and the operating system is shut down, the device will power off).

During startup, the controller 16 controls the upper cover 11 to open to a preset angle while simultaneously booting the operating system of the notebook computer.

It should be pointed out that in traditional notebook computers, the power key can only be operated after the upper cover is opened. Therefore, the upper cover must be opened first, followed by pressing the power key to start the operating system; without opening the upper cover, the power cannot be turned on. In contrast, due to the position of the power key 18, the notebook computer in this invention allows operation of the power key without the need to manually open the upper cover 11. Thus, when the user presses the power key, the upper cover 11 automatically opens and the operating system of the notebook computer starts simultaneously, saving boot-up time.

When shutting down, the controller 16 controls the upper cover 11 to close.

During this process, a current angle of the upper cover 11 may be recorded and taken as the preset angle. Thus, during the next startup, the upper cover 11 can automatically open to the previous angle.

While the upper cover 11 is closing, the operating system of the notebook computer is shut down. Once the operating system has shut down and the upper cover is fully closed, the power is disconnected. If the operating system has already shut down during the closing process, the power will be disconnected after the upper cover is completely closed. Conversely, if the upper cover is fully closed while the operating system is still shutting down, the power will be disconnected only after the operating system has finished shutting down.

It should be pointed out that traditional notebook computers typically require the operating system to be closed before the shutdown process. Only after the screen goes black and the computer powers off can the upper cover be closed, which can take a long time. In some cases, users may hastily shut down the computer and close the upper cover before the screen has gone black, causing the computer to remain partially powered on and resulting in battery drain by the next time it is used. The notebook computer in this invention automatically closes the upper cover while shutting down the operating system, thereby saving time and avoiding battery depletion due to rushed shutdowns.

Shutdown can be accomplished in two ways:
(1) select “Shut Down” in the operating system, and the controller 16 executes the shutdown based on a shutdown signal from the operating system;
(2) perform a sixth operation on the power key 18 (such as a long press), and the controller 16 executes the shutdown in response to the sixth operation.

2. Quickly adjust the angle of the upper cover.

In a powered-on state, the controller 16 responds to a first operation on the shortcut keys, the current angle of the upper cover 11 is obtained through the angle sensor 14, and the one-to-one correspondence between the current shortcut key and the angle is recorded, thereby binding the shortcut keys to the angles.

In the powered-on state, the controller 16 responds to a second operation on the shortcut keys, identifies the angle corresponding to the current shortcut key according to the correspondence, and controls the upper cover 11 to rotate to a position corresponding to the angle.

The binding of angles may be accomplished in the following way: when the duration and/or number of presses of a specific key reaches a preset time and/or count, the shortcut key will be bound to the angle.

For example, when the upper cover 11 is at 80 degrees, if the user long presses the numeric key “1”, the numeric key “1” will be bound to 80 degrees. In this way, multiple numeric keys can be bound to different angles as needed. After binding, when the numeric key “1” is pressed, the upper cover 11 can be rotated to a position corresponding to the 80-degree angle. Of course, this is merely an illustrative example of the first operation and the second operation and is not intended to be the only option.

### Embodiments of the Invention

As shown in FIGS. 1 and 8, an embodiment of this specification provides a notebook computer capable of conveniently adjusting an angle of an upper cover thereof, comprising an upper cover 11, a main housing 12, a driving motor 13, one or more shortcut keys, an opening and closing key, an angle sensor 14 for detecting an angle of the upper cover 11, a pressure sensor 15 for detecting external pressure on the upper cover 11 and the main housing 12, and a controller 16.

A front side of the upper cover 11 is provided with a display screen and a camera 19, a main unit is arranged in the main housing 12, and an upper side of the main housing 12 is provided with a built-in keyboard and a built-in touchpad.

The upper cover 11 and the main housing 12 form a shell, and are rotatably coupled through a coupling member 17. The coupling member 17 is connected with the driving motor 13, and the driving motor 13 is controlled by the controller 16, so that the upper cover 11 can rotate under the control of the controller 16 to adjust the angle.

The upper cover 11 and the main housing 12 may be connected through a single coupling member 17, as shown in FIGS. 1-3. Alternatively, the upper cover 11 and the main housing 12 may be connected through two coupling members 17 positioned at a lateral distance from each other, as shown in FIGS. 4-6.

It should be pointed out that notebook computers on the market today require users to manually lift the upper cover. Since a single coupling member can be subject to uneven stress, and it can be challenging to open the upper cover with the hand placed on one side, users generally have to position their hand at the top center of the upper cover for easier opening. As a result, two coupling members are usually adopted. However, the upper cover 11 of the notebook computer in this invention opens automatically, thus avoiding issues of uneven force and difficulty in opening, which enables the use of a single coupling member and saves costs.

To make it easier to turn on the notebook computer, the power key 18 is positioned where it can be accessed while the upper cover is closed, such as on an outer side of a frame of the upper cover 11, as shown in FIGS. 4-6, so that the power key 18 can be operated without manually opening the upper cover 11. Of course, the power key 18 may also be arranged on an outer side of a frame of the main housing 12, as shown in FIGS. 1-3, or at any location on a surface of the main housing 12, as shown in FIG. 8.

The plurality of shortcut keys may be keys on the built-in keyboard, such as numeric keys, and of course, they may also be keys arranged on the shell and separate from the built-in keyboard.

The opening and closing key is arranged on the shell in a position that allows it to be operated even when the upper cover is closed. In this embodiment, the power key 18 may be used as the opening and closing key.

The angle sensor 14 may be arranged on and/or in the notebook computer. As shown in the figures, the angle sensor 14 may be arranged on the coupling member 17 or directly on a shaft of the driving motor 13, as shown in FIG. 1; of course, the angle sensor 14 may also be a photoelectric sensor, as shown in FIG. 4, the upper cover 11 and the main housing 12 are each provided with a photoelectric sensor, with the two photoelectric sensors working together: one emits a light signal while the other receives it, thus detecting the angle of the upper cover 11. This is merely an exemplary illustration of the angle sensor and is not intended to be the only option.

The pressure sensor 15 may be arranged in the notebook computer and/or on the shell. For example, the pressure sensor 15 is installed in the upper cover 11, as shown in FIGS. 4 and 5, or as shown in FIG. 1, the pressure sensor may also be installed in the main housing 12. Of course, the pressure sensors 15 may also be installed in both the upper cover 11 and the main housing 12. This is merely an exemplary illustration of the pressure sensor 15 and is not intended to be the only option.

As shown in FIG. 7, the plurality of shortcut keys, the opening and closing key, the angle sensor 14 and the pressure sensor 15 are all in signal connection with the controller 16.

In this embodiment, the controller 16 is a CPU of the notebook computer and/or an independent control chip. As shown in FIGS. 1 and 4, the controller 16 is an independent control chip, which can communicate with the CPU of the notebook computer when necessary.

It should be pointed out that the angle in the invention refers to an included angle between the upper cover 11 and the main housing 12.

In addition to the ability to manually open and close the upper cover, the notebook computer in this embodiment also has the following functions.

1. Automatically open the upper cover during startup (when the operating system is activated) and automatically close the upper cover during shutdown (when the operating system is turned off; after the upper cover is closed and the operating system is shut down, the device will power off).

During startup, the controller 16 controls the upper cover 11 to open to a preset angle while simultaneously booting the operating system of the notebook computer.

It should be pointed out that in traditional notebook computers, the power key can only be operated after the upper cover is opened. Therefore, the upper cover must be opened first, followed by pressing the power key to start the operating system; without opening the upper cover, the power cannot be turned on. In contrast, due to the position of the power key 18, the notebook computer in this invention allows operation of the power key without the need to manually open the upper cover 11. Thus, when the user presses the power key, the upper cover 11 automatically opens and the operating system of the notebook computer starts simultaneously, saving boot-up time.

When shutting down, the controller 16 controls the upper cover 11 to close.

During this process, a current angle of the upper cover 11 may be recorded and taken as the preset angle. Thus, during the next startup, the upper cover 11 can automatically open to the previous angle.

While the upper cover 11 is closing, the operating system of the notebook computer is shut down. Once the operating system has shut down and the upper cover is fully closed, the power is disconnected. If the operating system has already shut down during the closing process, the power will be disconnected after the upper cover is completely closed. Conversely, if the upper cover is fully closed while the operating system is still shutting down, the power will be disconnected only after the operating system has finished shutting down.

It should be pointed out that traditional notebook computers typically require the operating system to be closed before the shutdown process. Only after the screen goes black and the computer powers off can the upper cover be closed, which can take a long time. In some cases, users may hastily shut down the computer and close the upper cover before the screen has gone black, causing the computer to remain partially powered on and resulting in battery drain by the next time it is used.

The notebook computer in this invention automatically closes the upper cover while shutting down the operating system, thereby saving time and avoiding battery depletion due to rushed shutdowns.

Shutdown can be accomplished in two ways:
(1) select “Shut Down” in the operating system, and the controller 16 executes the shutdown based on a shutdown signal from the operating system;
(2) perform a sixth operation on the power key 18 (such as a long press), and the controller 16 executes the shutdown in response to the sixth operation.

2. Quickly adjust the angle of the upper cover.

In a powered-on state, the controller 16 responds to a first operation on the shortcut keys, the current angle of the upper cover 11 is obtained through the angle sensor 14, and the one-to-one correspondence between the current shortcut key and the angle is recorded, thereby binding the shortcut keys to the angles.

In the powered-on state, the controller 16 responds to a second operation on the shortcut keys, identifies the angle corresponding to the current shortcut key according to the correspondence, and controls the upper cover 11 to rotate to a position corresponding to the angle.

The binding of angles may be accomplished in the following way: when the duration and/or number of presses of a specific key reaches a preset time and/or count, the shortcut key will be bound to the angle.

For example, when the upper cover 11 is at 80 degrees, if the user long presses the numeric key “1”, the numeric key “1” will be bound to 80 degrees. In this way, multiple numeric keys can be bound to different angles as needed. After binding, when the numeric key “1” is pressed, the upper cover 11 can be rotated to a position corresponding to the 80-degree angle. Of course, this is merely an illustrative example of the first operation and the second operation and is not intended to be the only option.

3. Finely adjust the angle of the upper cover.

In the powered-on state, the controller 16 increases the angle of the upper cover 11 according to a preset angle change increment in response to a third operation on an input device of the notebook computer.

In the powered-on state, the controller 16 decreases the angle of the upper cover 11 according to a preset angle change increment in response to a fourth operation on the input device of the notebook computer.

The angle change increment may be preset to any predetermined value, such as 5 degrees. By using the “Fn” key and/or other keys of the notebook computer, users may distinguish between normal use of the up and down keys or entering the upper cover adjustment mode. Pressing the “Fn” key and/or other keys along with the up and down arrow keys on the built-in keyboard will increase or decrease the angle of the upper cover 11 by 5 degrees with each press. Additionally, uniform and continuous adjustment of the angle may also be achieved through a predefined operation on a specific key. For example, a specific key may be long-pressed to initiate uniform and continuous adjustment. For another example, a hotkey combination (like Shift, Ctrl, Alt, etc., combined with a specified key) may be used to activate this uniform and continuous adjustment mode to accommodate the need for significant angle adjustments. Furthermore, users may increase or decrease the angle of the upper cover 11 using the built-in touchpad or an external mouse; for instance, pressing a key on the mouse may bring up an upper cover control interface on the display, allowing users to slide the built-in mouse or scroll the wheel and/or move the external mouse to increase or decrease the angle of the upper cover 11. Of course, this is merely an illustrative example of the third operation and the fourth operation and is not intended to be the only option.

4. Privacy screen.

In the powered-on state, in response to a fifth operation on the opening and closing key, the controller 16 assesses a current status of the upper cover 11, records the open angle, closes the upper cover 11 and updates the current status of the upper cover to closed if the upper cover is open, and opens the upper cover 11 based on the recorded open angle if the upper cover is closed.

This feature allows the user to pause usage of the notebook computer, such as when they need to step away, by pressing the opening and closing key to close the upper cover 11. When the notebook computer is to be used again, pressing the opening and closing key will open the upper cover 11 to the angle it was at when the user left.

By closing the upper cover 11, the notebook computer can maintain its current operating state or switch to the sleep mode.

If the upper cover 11 is opened while the notebook computer is in the sleep mode, it will exit the sleep mode.

To prevent the notebook computer from remaining open if it has not been used for a certain period, such as if the user forgets to close the upper cover 11 when leaving, the controller 16 uses a camera 19 to detect the absence of the user within a preset range. If the user is not detected within a preset time (e.g., 1 minute), a sensing device will send a signal to the controller to trigger the anti-peeping mode, which may include closing the upper cover 11.

5. Prevent accidental opening.

When the notebook computer is placed in a bag, if the power key 18 is accidentally pressed, the upper cover 11 will open automatically. In this case, the constraining force of the bag may damage the driving motor 13. Therefore, during startup, the controller 16 checks the pressure; if the pressure detected by the pressure sensor 15 exceeds the torque required to open the upper cover, it will stop the upper cover 11 from opening.

To further prevent accidental opening, the power key 18 is equipped with an anti-touch cover, which may be a flip cover or a slide cover.

To prevent the upper cover from rotating too quickly, which may damage the notebook computer or cause it to tip over, the controller 16 regulates the speed of the upper cover 11 as it rotates to a target angle:
controlling the upper cover 11 to rotate at a constant speed;
alternatively, controlling the upper cover 11 to rotate at a first speed, and as the upper cover approaches the target angle, controlling the upper cover 11 to rotate at a second speed to the target angle, where the second speed is less than the first speed.

For example, during startup, the controller 16 controls the upper cover 11 to open to a preset angle (90 degrees). Here, the target angle is 90 degrees. An angle of 80 degrees may be preset to represent an angle close to the target angle. Similarly, the target angle during shutdown is 0 degrees.

To differentiate the first operation, the second operation, the third operation, the fourth operation, the fifth operation, and the sixth operation from normal operations, the controller 16 checks whether the operations meet preset conditions when responding to these operations, and only responds to operations that do meet the conditions. For instance, the controller only responds if the duration and/or number of presses of a specific key reaches a preset time and/or count.

Alternatively, the controller 16 first checks whether the notebook computer is in the adjustment mode, and responds only to operations performed in the adjustment mode.

The adjustment mode may be activated or deactivated in the operating system through operations on the input device, such as pressing a specific key, or the adjustment mode may be set up as an application which can be opened or closed using the mouse.

Additionally, in the adjustment mode, parameters may be preset on the notebook computer, such as the aforementioned preset angle, preset angle change increment, preset time, and preset conditions.

Based on the same inventive concept, an embodiment of this specification further provides a method for adjusting the angle of the upper cover of the notebook computer, which comprises the following steps:
in a powered-on state, performing a first operation on the shortcut keys, allowing the notebook computer to obtain a current angle of the upper cover 11 through the angle sensor 14, and record the one-to-one correspondence between the current shortcut key and the angle; and
in the powered-on state, performing a second operation on the shortcut keys, allowing the notebook computer to identify the angle corresponding to the current shortcut key according to the correspondence, and control the upper cover 11 to rotate to a position corresponding to the angle.

Further, the angle of the upper cover 11 may be finely adjusted:
in the powered-on state, performing a third operation on an input device of the notebook computer to increase the angle of the upper cover 11; and
in the powered-on state, performing a fourth operation on the input device of the notebook computer to decrease the angle of the upper cover 11.

Further, the upper cover 11 may be automatically opened or closed, thereby preventing peeping:
in the powered-on state, performing a fifth operation on the opening and closing key to open or close the upper cover 11.

An upper cover opening and closing key of the notebook computer and a power on/off key (including the functions for turning on and off software and the screen) are combined into a single power key, which features a fingerprint recognition function.

However, those of ordinary skill in the art realize that the above embodiments are only used to illustrate the invention, and are not used as a limitation of the invention. As long as they are within the true spirit of the invention, changes and modifications to the above embodiments will fall within the scope of the claims of the invention.

### INDUSTRIAL APPLICABILITY

Enter the description paragraph for industrial applicability here

### FREE CONTENT OF SEQUENCE LIST

Enter the description paragraph for free content of the sequence list here

1. A notebook computer capable of conveniently adjusting an angle of an upper cover thereof, comprising a shell, wherein the shell comprises an upper cover and a main housing which are rotatably coupled by one or more coupling members, and the upper cover rotates under the control of a controller to adjust the angle; the notebook computer further comprises one or more shortcut keys and an angle sensor for detecting the angle of the upper cover, the one or more shortcut keys are arranged on the shell, and the one or more shortcut keys and the angle sensor are all in signal connection with the controller; and the controller is configured as follows:
in a powered-on state, upon receiving a first operation on the shortcut keys, the notebook computer obtains a current angle of the upper cover through the angle sensor, and records the one-to-one correspondence between the current shortcut key and the angle; and
in the powered-on state, upon receiving a second operation on the shortcut keys, the notebook computer identifies the angle corresponding to the current shortcut key according to the correspondence, and controls the upper cover to rotate to a position corresponding to the angle.

2. The notebook computer capable of conveniently adjusting an angle of an upper cover thereof according to claim 1, characterized in that, the controller is further configured as follows:
in the powered-on state, upon receiving a third operation on an input device, the notebook computer increases the angle of the upper cover according to a preset angle change increment; and
in the powered-on state, upon receiving a fourth operation on the input device, the notebook computer decreases the angle of the upper cover according to a preset angle change increment.

3. The notebook computer capable of conveniently adjusting an angle of an upper cover thereof according to claim 2, characterized in that, further comprising an opening and closing key arranged on the shell in a position that allows it to be operated when the upper cover is closed, the opening and closing key is in signal connection with the controller, and the controller is further configured as follows:
in the powered-on state, upon receiving a fifth operation on the opening and closing key, the notebook computer assesses a current status of the upper cover, records the open angle, closes the upper cover and updates the current status of the upper cover to closed if the upper cover is open, and opens the upper cover based on the recorded open angle if the upper cover is closed.

4. The notebook computer capable of conveniently adjusting an angle of an upper cover thereof according to claim 3, characterized in that, closing the upper cover and updating the current status of the upper cover to closed further comprises:
maintaining a current operating state of the notebook computer or switching the notebook computer to a sleep mode.

5. The notebook computer capable of conveniently adjusting an angle of an upper cover thereof according to claim 4, characterized in that, opening the upper cover based on the recorded open angle further comprises:
ending the sleep mode if the notebook computer is in the sleep mode.

6. The notebook computer capable of conveniently adjusting an angle of an upper cover thereof according to claim 5, characterized in that, the controller is further configured as follows:
if a designated object or target is not detected within a preset range by a camera within a specified time, the upper cover is closed.

7. The notebook computer capable of conveniently adjusting an angle of an upper cover thereof according to claim 6, characterized in that, a power key of the notebook computer is arranged in a position that allows it to be operated when the upper cover is closed, and the controller is further configured as follows:
during startup, the upper cover is controlled to open to a preset angle; and
when shutting down, the upper cover is controlled to close.

8. The notebook computer capable of conveniently adjusting an angle of an upper cover thereof according to claim 7, characterized in that, during startup, controlling the upper cover to open to a preset angle further comprises:
simultaneously booting an operating system of the notebook computer.

9. The notebook computer capable of conveniently adjusting an angle of an upper cover thereof according to claim 8, characterized in that, when shutting down, controlling the upper cover to close further comprises:
when shutting down, recording the current angle of the upper cover, taking the angle as the preset angle, and controlling the upper cover to close, at the same time, turning off the operating system of the notebook computer, and disconnecting the power after the operating system is turned off and the upper cover is closed.

10. The notebook computer capable of conveniently adjusting an angle of an upper cover thereof according to claim 9, characterized in that, the controller is further configured as follows:
the shutdown is executed based on a shutdown signal from the operating system; and
the shutdown is executed in response to a sixth operation on the power key by a user.

11. The notebook computer capable of conveniently adjusting an angle of an upper cover thereof according to claim 10, characterized in that, further comprising a pressure sensor for detecting external pressure on the upper cover and the main housing, the pressure sensor is in signal connection with the controller, and the controller is further configured as follows:
during startup, if the pressure detected by the pressure sensor exceeds the torque required to open the upper cover, the upper cover is stopped from opening.

12. The notebook computer capable of conveniently adjusting an angle of an upper cover thereof according to claim 11, characterized in that, the input device comprises a built-in keyboard, a built-in touchpad and an external mouse, the shortcut keys are keys on the built-in keyboard, the opening and closing key is the power key, and the controller is a CPU of the notebook computer and/or an independent control chip.

13. he notebook computer capable of conveniently adjusting an angle of an upper cover thereof according to claim 12, characterized in that, the controller regulates a speed of the upper cover as the upper cover rotates to a target angle:
controlling the upper cover to rotate at a constant speed;
alternatively, controlling the upper cover to rotate at a first speed, and as the upper cover approaches the target angle, controlling the upper cover to rotate at a second speed to the target angle, the second speed being less than the first speed.

14. The notebook computer capable of conveniently adjusting an angle of an upper cover thereof according to claim 13, characterized in that, when responding to the operations, the controller checks whether the operations meet preset conditions, and only responds to operations that do meet the conditions; alternatively, the controller checks whether the notebook computer is in an adjustment mode, and responds only to operations performed in the adjustment mode.

15. The notebook computer capable of conveniently adjusting an angle of an upper cover thereof according to claim 14, characterized in that, upon receiving an operation on the input device, the notebook computer activates or deactivates the adjustment mode.

16. The notebook computer capable of conveniently adjusting an angle of an upper cover thereof according to Claimt of 15, characterized in that, the power key of the notebook computer is equipped with an anti-touch cover which is a flip cover or a slide cover.

17. A method for adjusting an angle of an upper cover of the notebook computer capable of conveniently adjusting an angle of an upper cover thereof, characterized in that, comprising:
in a powered-on state, performing a first operation on the shortcut keys, allowing the notebook computer to obtain a current angle of the upper cover through the angle sensor, and record the one-to-one correspondence between the current shortcut key and the angle; and
in the powered-on state, performing a second operation on the shortcut keys, allowing the notebook computer to identify the angle corresponding to the current shortcut key according to the correspondence, and control the upper cover to rotate to a position corresponding to the angle.

18. The method for adjusting an angle of an upper cover according to claim 17, characterized in that, further comprising:
in the powered-on state, performing a third operation on the input device of the notebook computer to increase the angle of the upper cover; and
in the powered-on state, performing a fourth operation on the input device of the notebook computer to decrease the angle of the upper cover;
wherein the controller is configured as follows:
in the powered-on state, upon receiving the third operation on the input device, the notebook computer increases the angle of the upper cover according to a preset angle change increment; and
in the powered-on state, upon receiving the fourth operation on the input device, the notebook computer decreases the angle of the upper cover according to a preset angle change increment.

19. The method for adjusting an angle of an upper cover according to claim 18, characterized in that, further comprising:
in the powered-on state, performing a fifth operation on the opening and closing key to open or close the upper cover;
wherein the opening and closing key is arranged on the shell in a position that allows it to be operated when the upper cover is closed, the opening and closing key is in signal connection with the controller, and the controller is further configured as follows:
in the powered-on state, upon receiving the fifth operation on the opening and closing key, the notebook computer assesses a current status of the upper cover, records the open angle, closes the upper cover and updates the current status of the upper cover to closed if the upper cover is open, and opens the upper cover based on the recorded open angle if the upper cover is closed.

20. A notebook computer, comprising a shell, characterized in that, an upper cover opening and closing key of the notebook computer and a power on/off key (comprising the functions for turning on and off software and a screen) are combined into a single power key, the power key is arranged outside the notebook computer, and the power key features a fingerprint recognition function.
